(19) United States
(12) Patent Application Publication
(10) Pub. No.: US 2021/0291803 A1
(43) Pub. Date: Sep. 23, 2021

(54) HYBRID VEHICLE PREDICTIVE POWER CONTROL SYSTEM SOLUTION

(71) Applicants: Wangie Gesang, Shanghai (CN); Wei Cha, Shanghai (CN); LCB International Inc., Shanghai (CN)

(72) Inventors: Wangjie Gesang, Shanghai (CN); Wei Cha, Shanghai (CN)

(21) Appl. No.: 17/260,435

(22) PCT Filed: Sep. 6, 2019
(86) PCT No.: PCT/CN2019/104736

§ 371 Date: Jan. 14, 2021

(30) Foreign Application Priority Data
Jul. 18, 2018 (CN) 201810792788.2

(51) Int. Cl. B60W 20/11; B60K 6/26; B60K 6/54; B60W 20/12

(52) U.S. Cl. CPC B60W 20/11; B60K 6/26; B60K 6/54; H02P 27/06; B60W 2556/60; B60W 2556/50; B60Y 2200/92; B60W 20/12

(57) ABSTRACT

The embodiment of the invention provides a predictive power control system for hybrid vehicles. The system is mainly specific to the application scenarios of long-distance freight heavy trucks. Based on the vehicle configuration parameters and the current operating conditions, and with the aid of a vehicle-mounted expressway electronic navigation three-dimensional map, the system can be used to accurately and real-timely predict the dynamic road load power time-space function within the range of tens of kilometers of the electronic horizon in front of the vehicle; an electric power shunt device is commanded through a vehicle controller, and the flow direction and amplitude of 100-kilowatt level electric power can be accurately and continuously adjusted among an engine-driven generator set, a battery pack and a driving motor within tens of milliseconds of system response time so that an engine works stably in the high efficiency area of the engine for a long time; and the road load transient power balance required by a vehicle dynamic equation can be met through hundreds of kilowatts of fast charging and discharging of the battery pack in real time. Compared with traditional diesel heavy trucks, the hybrid heavy truck has the advantage that the overall fuel consumption and emissions in real world operation are reduced greatly on the premise of ensuring the vehicle power, freight timeliness and driving safety.

### TECHNICAL FIELDS

The invention relates to a predictive power control device and method for hybrid vehicles, in particular to the predictive vehicle power control based on artificial intelligence in application scenarios of long-distance freight heavy trucks with normal load and mainly running on expressways to achieve the adaptive cruise control and the beneficial effect of minimizing the overall fuel consumption and emissions during the operation of vehicles.

### ADVANCED TECHNOLOGY

At present, the mandatory regulations of Europe and America on emissions from large commercial vehicles including heavy duty trucks (short for heavy trucks, the gross vehicle weight is more than 15 tons) have turned to the regulations focusing on carbon emissions of greenhouse gas, giving priority to carbon dioxide (CO₂), from the regulations (Euro VI, fully implemented in Europe, 2014) focusing on emissions and EPA2010 (fully implemented in America, 2010). The carbon emission (g/km) of the vehicle is proportional to the fuel consumption (L/100 km) of the vehicle. The regulations on greenhouse gas from medium duty/heavy duty engines and commercial vehicles (GHG Phase II) issued by the United States Federal Government in 2016 explicitly specify the fuel economy (mile/gallon) of all new medium duty/heavy duty engines and commercial vehicles sold in America is improved greatly and the fuel consumption (L/100 km) and carbon emissions (g/ton-km) are reduced by 2021-2027 on the premise of maintaining the limits for pollutant and exhaust emissions in EPA2010 unchanged. In May, 2018, the European Union officially starts the approval procedures of the mandatory regulations on carbon emissions from heavy duty freight trucks (the gross weight is more than 3.5 tons) in 2020-2030.

The Limits and Measurement Methods for Emissions from Light-duty Vehicles (V) came into operation in China, 2017, and it is predicted that the Limits and Measurement Methods for Emissions from Light-duty Vehicles (VI) come into operation in 2020. The Limits and Measurement Methods for Emissions from Light-duty Vehicles (VI) are basically the same as Euro VI and EPA2010 in the aspect of limits for emissions, and have similar requirements for reducing the fuel consumption and carbon emissions of the vehicles year by year.

After 2020, the regulations and industry focus of China. America and European Union as the three major heavy truck markets in the world will be turned to reduction of fuel consumption and carbon emissions from reduction of emissions. The average fuel cost of a long-distance freight heavy truck is approximately USD 60 thousands per year in America, and the average fuel cost of a long-distance freight heavy truck is approximately RMB 400 thousands in China and Europe. The fuel consumption and emissions of the heavy trucks are reduced through technical innovation, which is of great significance to main engine plants, drivers, fleets, shippers, governments, societies, etc.

America leads the world in the development of the regulations and technologies on emissions from the heavy trucks and reduction of fuel consumption. As a part of the Super Truck project led and subsidized by the Energy Department of the United States, four teams led by major heavy truck main engine plants in North America created four super heavy sample trucks through five years of research and development, and achieved the goal of improving the fuel economy (gallon/ton-mile) by 50% for freight heavy trucks by the end of 2016 compared with 2009.

The Super Truck project of America integrates various energy-saving and emission reduction technologies which may be subjected to commercial mass production before 2025. The future main challenge is to improve the comprehensive cost performance of implementation of various energy-saving technologies. At present, the medium and long-term challenges in the U.S. heavy truck industry are how to achieve the mandatory requirements for 2027 heavy truck fuel consumption of GHG Phase TI on the premise of controlling the price rise of new heavy trucks effectively. The stakeholders of the heavy truck industry in China need to face the severe test that the retail price of new heavy trucks meeting the requirements of the Limits and Measurement Methods for Emissions from Light-duty Vehicles (VI) in 2020 are estimated to rise greatly compared with the selling price of current heavy trucks meeting the requirements of the Limits and Measurement Methods for Emissions from Light-duty Vehicles (V).

In last ten years, in the world's major automobile markets, especially the world's largest Chinese automobile market, there are successful cases of mass commercial use of electric or hybrid passenger vehicles and large buses heavily subsidized by the government. However, on the largest/most technologically advanced long-distance freight heavy truck markets of China. America and European Union, domestic and foreign industry experts agreed that the mass commercial use of electric heavy trucks or hybrid heavy trucks cannot be achieved without subsidies before 2030. Refer to Ricardo (2017), “Heavy Duty Vehicle Technology Potential and Cost Study”, Final Report for ICCT for details.

Invention Content

The energy of hybrid vehicles is effectively recovered by restricting the internal combustion engine to operate at the high efficiency area and regenerative braking of a driving motor in the cities that the vehicles need to accelerate and apply brakes frequently or under the working conditions of suburbs, which greatly reduces the fuel consumption compared with traditional internal combustion engine vehicles, with obvious energy saving and emission reduction effects and high cost performance, thus achieving the mass commercial use of the hybrid vehicles. For long-distance freight trucks, the vast majority of the running time or mileage within the product life cycle occurs under the expressway conditions, and the acceleration and braking are not frequent. The internal combustion engines of traditional vehicles stably work at the high efficiency area for a long time under the expressway conditions, while the regenerative braking energy recovery function of the hybrid vehicles is useless; in addition, the hybrid vehicles have additional loss due to multiple energy conversion among chemical energy, mechanical energy, electric energy and mechanical energy, so the global industry considers that the largest drop of the fuel consumption of the long-distance freight hybrid heavy trucks (hereafter referred to as hybrid heavy trucks) does not exceed 10% compared with the overall fuel consumption of traditional diesel engine vehicles. According to the technical and industrial development status of current international/domestic three major powers (battery, motor and electronic control), compared with traditional diesel engine heavy trucks, the cost growth of hybrid heavy trucks is too high, but the fuel saving effect is not obvious; and consequently the cost performance of the hybrid heavy trucks is low. The traditional wisdom of the global heavy truck industry considers that the mass commercial use of the hybrid heavy trucks cannot be achieved without subsidies before 2030.

The highway freight industry faces another major challenge that the shortage of drivers and turnover rates are high throughout the year. For the same heavy trucks, loads and routes, drivers with different experiences and capabilities can result in the overall fuel consumption difference up to 25%. Lots of freight transport companies reduce the difference between the actual fuel consumption and the optimal fuel consumption, caused by human factors of drivers, though various methods, such as training, fuel-efficient rewards and punishments, sensors and big data analysis.

In order to achieve the mass commercial use of long-distance freight hybrid heavy trucks, it is necessary to greatly improve the cost performance. The average selling price of the long-distance freight hybrid heavy trucks is three to six times the average selling price of common passenger vehicles in America or China, but the annual fuel cost of the long-distance freight hybrid heavy trucks is 30 to 60 times the annual fuel cost of common internal combustion engine passenger vehicles. The retail price of gasoline or diesel in America and China is far lower than the retail price of the gasoline or diesel in Europe. Two effective methods for improving the cost performance of the long-distance freight hybrid heavy trucks are provided, one is to increase the fuel consumption drop compared with the fuel consumption of traditional diesel engine vehicles, and the other is to reduce the difference between the cost of the hybrid heavy trucks and the cost of the traditional diesel engine vehicles.

The traditional wisdom of global automobile industry experts, especially the heavy truck industry experts, has historical limitations, and they all ignore the secret source for reducing the fuel consumption of the long-distance freight hybrid heavy trucks greatly, that is the 100-kilowatt level slope power time function Pg(t) caused by small changes of the road longitudinal slope (short for the “longitudinal slope”) when the vehicle loads cargoes and runs on a closed expressway. The core of the invention is to reduce the overall fuel consumption of long-distance freight hybrid heavy trucks by 30% compared with traditional diesel engine vehicles through the effective integration of fuel-electric hybrid technology, satellite navigation, Internet of Things, big data, artificial intelligence and other strategic emerging technologies to greatly improve the cost performance of hybrid heavy trucks; by 2023, the mass commercial use of the long-distance freight hybrid heavy trucks will be achieved on the three major heavy truck markets, namely America. China and European Union.

The first principle of the oil-saving technology of the long-distance freight hybrid heavy trucks is the vehicle longitudinal dynamic equation that the automobile industry is very familiar with:

$${P}_{v} = \frac{v}{1000 η} ( {Mgf}_{r} cos α + \frac{1}{2} ρ \text{?} C \text{?} A \text{?} {V}^{2} + Mg sin α + M δ \frac{dV}{dt} )$$

$$\text{?} \text{indicates text missing or illegible when filed}$$

Where, Pᵥ is the vehicle power or the road load power, and the unit of all power items is kilowatt (KW).

The rolling power Pᵣ refers to the required power for overcoming the tire rolling friction resistance when the vehicle runs, and the rolling power can be shown in the following formula (1):

$${P}_{r} = \frac{v}{1000 η} ( {Mgf}_{r} cos α ) , \qquad ( 1 )$$

The wind resistance power P_{d} refers to the required power for overcoming air resistance (calm weather) when the vehicle runs, and the wind resistance power can be shown in the following formula (2):

$${P}_{d} = \frac{v}{1000 η} ( \frac{1}{2} ρ \text{?} {C}_{D} A \text{?} {V}^{2} ) , \\ \text{?} \text{indicates text missing or illegible when filed} \qquad ( 2 )$$

The slope power P_{g} refers to the required power for overcoming the gravity when the vehicle runs uphill, and the slope power of the vehicle running downhill is a negative value, representing the driving power generated by conversion between the potential energy and the kinetic energy of the vehicle; and the slope power P_{g} can be shown in the following formula (3):

$${P}_{g} = \frac{v}{1000 η} ( Mg sin α ) \qquad ( 3 )$$

The accelerating power Pₐ refers to the required additional power for the vehicle reaching the predetermined acceleration when running on a level road. When the acceleration is a negative value, it represents mechanical braking for converting the kinetic energy of the vehicle into thermal energy, or regenerative braking for converting most of the kinetic energy of the vehicle into the electric energy to be recycled. The accelerating power Pₐ can be shown in the following formula (4):

$${P}_{a} = \frac{v}{1000 η} ( M δ \frac{dV}{dt} ) \qquad ( 4 )$$

In the above formulas (1)-(4): V is the vehicle speed (m/s)ηₜ is the efficiency of the vehicle rotating system; M is the gross vehicle weight (kg); g is the acceleration of gravity, and is equal to 9.8 (m/s²); fᵣ is the tire rolling friction coefficient; a is the highway longitudinal slope angle; the positive value represents upslope, and the negative value represents downslope; Pₐ is air density (kg/m³); C_{D} is the vehicle wind resistance coefficient; A_{f} is the area (m²) in front of the vehicle; δ is the rolling mass conversion coefficient; dV/dt is the vehicle acceleration, and the positive value represents acceleration; and the negative value represents deceleration.

Braking and acceleration are seldom performed under the expressway running condition. When the vehicle runs at constant speed, the accelerating power is zero; the rolling power is basically unchanged on a highway section with a small slope; the wind resistance power is a constant, and only the slope power is a time variable; and the change amplitude of the slope power is proportional to the slope change of the expressway section.

The gross weight limit of the long-distance freight heavy truck in China is 40 tons, and the maximum statutory speed limit is 90 km/h; major highways in China are jammed for a long term, and the average speed of the heavy trucks in the road logistics industry is 60 km/h only; the gross weight limit of the long-distance freight heavy truck in America is 36 tons, and the maximum statutory speed limit is up to 125 km/h; and the average running speed of the heavy trucks in the road logistics industry is higher than 80 km/h. Most American transport companies limit the maximum speed of the heavy trucks to 105 km/h in view of fuel saving mainly.

For example, for a heavy truck with the gross weight of 40 tons and the speed of 60 km/h, the required slope power is up to 228 KW when the vehicle meets a small slope, namely that the road longitudinal slope is 2.0; and at the moment, the sum of the rolling friction power and the wind resistance power of the vehicle is 71 KW. When the total power margin of the vehicle is insufficient, the vehicle needs to shift gears and speeds down to continuously run uphill. Compared with a passenger vehicle with the gross weight of 2 tons, the slope power at the moment is only 11.4 KW; for passenger vehicles with the power margin of nearly 100 KW, it is not required to consider, and the vehicle runs as easily as walking on firm earth. In other words, for each full-load heavy truck running on a highway, every 1.0 degree change, which is hard to see by naked eyes, of the road longitudinal slope means that the road load power of the vehicle has a great change of 100 KW above.

The road longitudinal slope is short for “longitudinal slope”, and there are two unit of measurement; one is the included angle between the road surface and the horizontal plane, and the other is the proportion of the road surface elevation to the horizontal projection distance of the road section, shown in %. Most countries limit the longitudinal slope within the range of −7.0%˜+7.0% in highway design and construction, which is mainly based on consideration of ensuring that the full-load heavy truck runs on a highway safely and effectively.

The vehicle needs to achieve the moderate braking of 2 m/s² (0.2 g) at the speed of 60 km/h; for the passenger vehicle with the gross weight of 2.0 tons, the required accelerating power or braking power is 67 KW; but for the heavy truck with the gross weight of 40 tons, the required accelerating power or braking power can be up to 1333 KW. The accelerating power peaks of the fuel-electric hybrid vehicles for recycling energy through regenerative braking are all basically 250 KW below. The energy of the braking power higher 250 KW cannot be recovered, and can only be converted into thermal energy wasted through mechanical braking. Thus, under the mixed running conditions of a city or a suburb where the acceleration/deceleration is frequent, the fuel saving of the hybrid vehicles is more obvious than the fuel saving of traditional internal combustion engine vehicles.

Under the running conditions of closed highways with infrequent acceleration and deceleration, compared with the fuel saving effect of the internal combustion engine vehicle, the fuel saving effect of the hybrid vehicle is not obvious, or even the fuel consumption is increased slightly. The traditional wisdom of the automobile field is applicable for all hybrid passenger vehicles (the gross weight is less than three tons) and parallel hybrid large commercial vehicles. However, inventors find that the traditional wisdom is not applicable for advanced series hybrid heavy trucks at the long-distance freight application scenarios.

In the recent ten years, for some medium and high-end heavy trucks with internal combustion engines in Europe and America, fuel has been saved through the predictive cruise control by using the vehicle-mounted three-dimensional map comprising the road longitudinal slope information. However, the predictive cruise of traditional heavy trucks has limitations and shortcomings: a purely mechanical power assembly is not applicable for largely changing the output power of the internal combustion engine instantaneously (sub-second level), and the automatic transmission shifts gears frequently; the predictive cruise control is only applicable for steep slopes with the longitudinal slope angle of larger than 2.0 degrees and the longitudinal slope of several kilometers above; the vehicle has no regenerative braking function, and conversion between the potential energy and the kinetic energy of the vehicle on the steep slopes cannot be recycled dynamically, and the overall fuel consumption drop in actual operation does not reach 3.0%.

It should be noted that there are no absolutely horizontal highways in the world. Even in plain areas, longitudinal slopes between ±4.0 degrees are continuously distributed along meter-level road sections of the highways. For loaded heavy trucks running at constant speed under the highway conditions, the biggest impact on the time variable of the road load total power Pᵥ is the slope power P_{g}, and the sum of the rolling P_{f} and the wind resistance power P_{d} can be approximated as a constant. If there is a vehicle-mounted electronic navigation three-dimensional map on which the highway longitudinal slope, the road positioning meter-level precision (longitude and latitude) and the longitudinal slope measurement accuracy reach 0.1 degree, by the aid of vehicle-mounted Internet of Things and the meter-level high-precision satellite navigation and according to the vehicle kinetic equation, the vehicle control unit (VCU) can real-timely and accurately predict the road load variation of the vehicle within hundreds of kilometers, especially the 10-kilowatt precision time variation of the slope power P₈ and the road load power within the range of hundreds of kilometers of the electronic horizon in front of the vehicle. The predictive refresh frequency of the VCU can be up to 10.0 hertz (Hz), that is to say, the VCU can refresh the power prediction every 2-3 meters that the vehicle runs.

The electronic navigation three-dimensional map can provide electronic horizon for the vehicle. The electronic horizon refers to the road information, especially the information of longitude, latitude and longitudinal slope of the highways along the way, contained in the three-dimensional map within the specified range in front of the heading of the vehicle. The predictive control is implemented for the traditional diesel engine heavy trucks, and limited to the power assembly, and the traditional diesel engine heavy trucks are not suitable for quick and continuous change of the working conditions, and have no regenerative braking energy recovery function; and only the electronic horizon within the range of five kilometers can be used effectively. However, according to the hybrid heavy truck provided by the invention, the electronic horizon within the range of 50, even 500 kilometers can be used effectively. Refer to the following for details.

According to the predictive power control system for the hybrid vehicles, an electric power shunt device (ePSD) is commanded through a vehicle control unit of the predictive power control system, and 100-kilowatt level electric power can be accurately and continuously adjusted among an engine-driven generator set, a battery pack and a driving motor within tens of milliseconds of system response time so that an engine works stably in the high efficiency area of the engine for a long time; and the 100-kilowatt level transient change of the slope power within the sub-second time is offset through 100-kilowatt level fast charging and discharging of the battery pack in real time, and the road load power balance required by a vehicle dynamic equation is met. Compared with traditional diesel engine vehicle, the hybrid heavy truck has the advantage that the overall fuel consumption drop in actual operation can reach 30% on the premise of ensuring the power, freight timeliness and safety of the hybrid heavy trucks.

The first aspect of the invention provides a hybrid vehicle comprising a generator set, used for converting chemical energy of vehicle fuel into electric energy, an electric power shunt device (ePSD), configured as a power electronic network with three ports, wherein the first port of the ePSD is connected with the output end of the generator set unidirectionally and electrically; a battery pack, connected with the second port of the ePSD bidirectionally and electrically; a DC/AC inverter, connected with the third port of the ePSD bidirectionally and electrically; an automatic transmission, connected with a transmission shaft of the vehicle bidirectionally and mechanically; a navigator, used for pre-storing an electronic navigation three-dimensional map comprising the three-dimensional information of the longitude, latitude and latitude of a longitudinal road at the road section where the vehicle runs; at least one driving motor, connected with the inverter bidirectionally and electrically, and connected with the transmission bidirectionally and mechanically, wherein the driving motor can be operated for converting the electric energy into the mechanical energy for driving the vehicle, or converting the mechanical energy into the electric energy, and charging the battery pack through the inverter and the ePSD; wherein, no mechanical connection exists between the generator set and the deriving motor or between the generator set and the automatic transmission; the vehicle further comprises a vehicle control unit (VCU), and the vehicle control unit is used for controlling at least one of the generator set, the ePSD, the driving motor, the automatic transmission and the battery pack based on data in a vehicle-mounted satellite navigation receiver and/or the navigator through a data bus of the vehicle independently.

In some embodiments, the hybrid vehicle further comprises a satellite navigation receiver which is a dual-antenna carrier phase real-time kinematic (RTK) differential receiver, capable of calculating the longitude, latitude, altitude, longitudinal slope and linear velocity of a longitudinal road in the running process of the vehicle in real time; or a high precision single-antenna satellite navigation receiver, capable of calculating the longitude, latitude, slope and linear velocity of the longitudinal road at the meter-level positioning precision in the running process of the vehicle in real time.

In some embodiments, the VCU is configured for predictive control over the generator set and the battery pack based on the longitude and latitude, calculated by the navigator in real time, of the vehicle in the running process, and in combination with the longitude, latitude and longitudinal slope, stored in the three-dimensional map, of the longitudinal road within the electronic horizon range in front of the vehicle; and/or predictive control over the generator set and the battery pack based on the longitude, latitude, slope and linear velocity, calculated by the RTK receiver, of the vehicle in the running process, and in combination with the longitude, latitude and longitudinal slope, stored in the three-dimensional map, of the longitudinal road within the electronic horizon range in front of the vehicle.

In some embodiments, the VCU is further configured for predictive control over the generator set and the battery pack based on the longitudinal slope calculated by the RTK receiver and the electronic horizon of the three-dimensional map in the running process of the vehicle when it is detected that the difference between the longitudinal slope calculated by the RTK receiver and the longitudinal slope of the same position stored in the three-dimensional map exceeds the allowable tolerance.

In some embodiments, the VCU is further configured for calibrating built-in clocks, comprising the built-in clocks of the VCU, of subsystem microprocessors based on the time service of the RTK receiver in real time, and annotating the data in the unique time series; establishing a data set by assembling the measurement parameters and/or operating parameters of at least two subsystems of the RTK receiver, the navigator, the generator set, the ePSD, the inverter, the driving motor, the automatic transmission and the battery pack on the first dimension; arranging a plurality of data sets on the second dimension according to the time series provided by the calibrated clock so as to form a dedicated structured big data packet used for describing the dynamic operating condition of the hybrid vehicle.

In other words, the VCU is configured for calibrating built-in clocks, comprising the built-in clocks of the VCU, of subsystem microprocessors based on accurate time service of the RTK receiver, and annotating the data in the unique time series; assembling the measurement parameters and/or operating parameters of at least two subsystems of the RTK receiver, the navigator, the generator set, the ePSD, the inverter, the driving motor, the automatic transmission and the battery pack into the dedicated structured big data packet used for describing the dynamic operating condition of the hybrid vehicle.

Optionally, the dedicated structured big data packet can be encrypted, and accordingly safely uploaded to the cloud computing platform for storage through the mobile Internet in real time or in time afterwards, for subsequent analysis and processing.

In some embodiments, the generator set is composed of an internal combustion engine, an alternator and an AC/DC converter, wherein the internal combustion engine is connected with the alternator unidirectionally and mechanically, and the alternator is connected with the AC/DC converter unidirectionally and electrically; and the AC/DC converter is connected with the ePSD unidirectionally and electrically.

In some embodiments, the VCU is configured for control over at least one of the internal combustion engine, the battery pack, the automatic transmission and the driving motor based on a universal characteristic curve digital model of the internal combustion engine, the charge-discharge characteristic digital model of the battery pack, the characteristic digital model of the automatic transmission and the characteristic digital model of the driving motor correspondingly.

In some embodiments, the universal characteristic curve digital model of the internal combustion engine comprises an idle working point without road load, and a high efficiency working area with minimum specific fuel consumption in the engine, and the VCU is further configured for enabling the internal combustion engine to work basically at the idle working point or the high efficiency working area; smooth switching among different working conditions can be achieved.

In some embodiments, the VCU is further configured for storing the dedicated structured big data packet in the running process of the vehicle; and sending and storing the stored structured big data packet to the cloud computing platform arranged far away from the vehicle through a mobile Internet real-timely or periodically for providing the dedicated structured big data packet required for artificial intelligence training on fuel-efficient strategy through the cloud platform.

The second aspect of the invention provides a cloud computing platform, comprising at least one cloud server; each server comprises a processing unit; and a memory, coupled to the processing unit and comprising computer program codes; when the computer program codes are executed through the processing unit, the server executes the following operations of:

receiving and storing the dedicated structured big data from the multiple hybrid vehicles through the mobile Internet, wherein the vehicle comprises:
a generator set, used for converting chemical energy of vehicle fuel into electric energy;
an electric power shunt device (ePSD), configured as a power network with three ports, wherein the first port of the ePSD is connected with the output end of the generator set unidirectionally and electrically;
a battery pack, connected with the second port of the ePSD bidirectionally and electrically;
a DC/AC inverter, connected with the third port of the ePSD bidirectionally and electrically;
an automatic transmission, connected with a transmission shaft of the vehicle bidirectionally and mechanically;
a navigator, used for pre-storing an electronic navigation three-dimensional map comprising the three-dimensional information of the longitude, latitude and longitudinal slope of the longitudinal road at the road section where the vehicle runs;
at least one driving motor, connected with the inverter bidirectionally and electrically, and connected with the transmission bidirectionally and mechanically, wherein the driving motor can be operated for converting the electric energy into the mechanical energy for driving the vehicle, or converting the mechanical energy into the electric energy, and charging the battery pack through the inverter and the ePSD; wherein, no mechanical connection exists between the generator set and the deriving motor or between the generator set and the automatic transmission;
a vehicle control unit (VCU) used for controlling at least one of the navigator, the generator set, the ePSD, the driving motor, the automatic transmission and the battery pack based on data in a vehicle-mounted satellite navigation receiver and/or the navigator through a data bus of the vehicle independently;

forming dedicated machine learning algorithms based on the dedicated structured big data received from the multiple vehicles;

conducting training on a fuel-saving artificial intelligence unit based on the formed dedicated machine learning algorithms through the computing capability of the cloud platform, wherein the structured big data comprises the data related to at least one of the generator set, the ePSD, the inverter, the driving motor, the automatic transmission and the battery pack; and

making a response to the request of a certain hybrid vehicle; aiming at the vehicle-specific journey, the fuel-saving artificial intelligence unit provides customized fuel-saving strategies as the default initial scheme of the fuel-saving strategies of the VCU.

In some embodiments, wherein, each vehicle further comprises a high precision satellite navigation receiver which is a dual-antenna carrier phase real-time kinematic (RTK) differential receiver, used for accurately calculating the longitude, latitude, altitude and longitudinal slope of a longitudinal road and the linear velocity of the vehicle in the vehicle running process in real time, wherein the measurement data received from the multiple vehicles further comprises road three-dimensional data comprising the longitude, latitude and longitudinal slope, measured by the multiple vehicles at the same road section of a running way, of a plurality of longitudinal roads, and the operations further comprise: transmitting the multiple road three-dimensional data to electronic navigation three-dimensional map manufacturers; and updating the three-dimensional map stored in the vehicle navigator.

Thus, the precision of the three-dimensional map can be improved in a crowd-sourcing mode continuously, and the freshness of the three-dimensional map is kept; and the three-dimensional map stored in the vehicle navigator is updated continuously.

Schematic Illustration

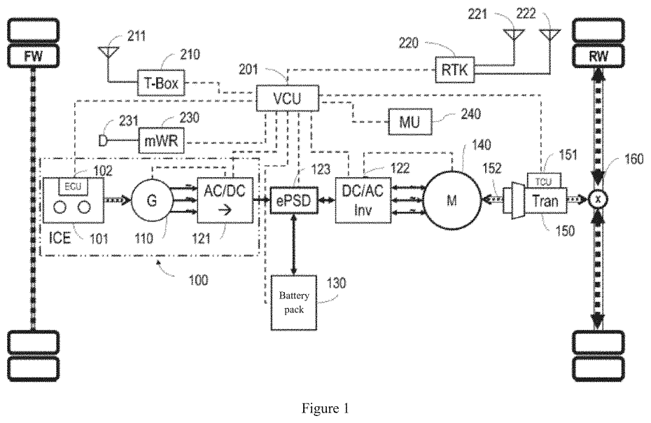

FIG. 1 is a system block diagram of the hybrid heavy truck disclosed by one embodiment of the invention;

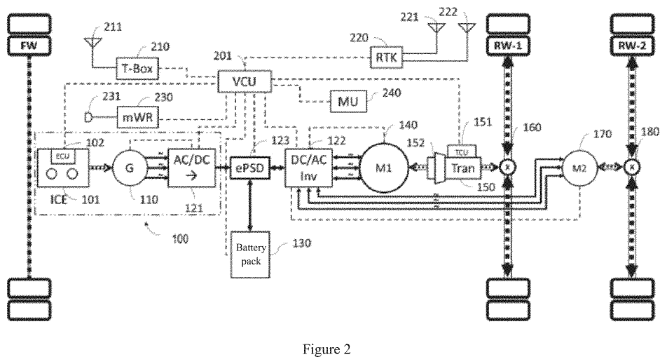

FIG. 2 is a system block diagram of the hybrid heavy truck disclosed by another embodiment of the invention;

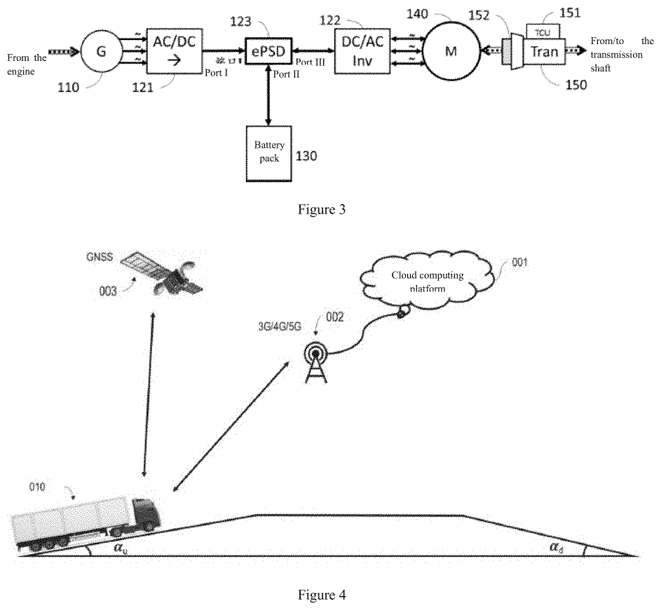

FIG. 3 is a part of a system block diagram of the hybrid heavy truck disclosed by one embodiment of the invention; and

FIG. 4 is a system block diagram of data switching between the hybrid heavy truck and the mobile Internet and the cloud computing platform disclosed by one embodiment of the invention;

In these figures, the same or similar reference symbols are used for representing the same or simile elements.

### MODE OF EXECUTION

The following is the description of the embodiments by reference to some examples. It should be known that the description of these embodiments are only for those skilled in the art to properly understand the invention and accordingly achieve the invention, and are not hints of limitations to the invention.

For example, the term “including” and the variants thereof should be interpreted as the open term of “including but not limited to”. The term “based on” should be interpreted as “at least partially based on”. The term “an embodiment” and “a kind of embodiment” should be interpreted as “at least one embodiment”. The term “another embodiment” should be interpreted as “at least one other embodiment”. The terms “first”. “second” and the like can refer to different or the same objects. The followings may include other definite and implicit definitions.

The following is the description of the basic principles and some embodiment of the invention by reference to the figures. FIG. 1 shows the power assembly, the vehicle control unit, core sensors and other devices of the hybrid heavy truck disclosed by the embodiment of the invention. The system can be not only a set of 4×2 system with only one driving shaft (connected with a rear wheel “RW”), but also a set of 6×2 system comprising a driving shaft and a driven shaft. FIG. 2 shows a set of 6×4 hybrid heavy truck power assembly system comprising two driving shafts (connected with the rear wheels “RW-1” and “RW-2” separately). The heavy truck adopting the systems in FIG. 1 and FIG. 2 can be called the ACE heavy truck. In some embodiments, the heavy truck can be the hybrid heavy truck with the gross weight of larger than 15 tons for main line freight.

As shown in FIG. 1, generally, the ACE heavy truck comprises a generator set 100, an electric power shunt device (ePSD) 123, a battery pack 130, a DC/AC inverter (DC/AC Inv) 122, an automatic transmission (Tran) 150, at least one driving motor 140 and a vehicle control unit (VCU) 201.

Specifically, the generator set 100 is used for converting chemical energy of vehicle fuel into electric energy. As shown in FIG. 3, the ePSD 123 is a power network with three ports, wherein the port I (also called “the first port”) of the ePSD is connected with the output end of the generator set 100 unidirectionally and electrically. The battery pack 130 is connected with the port II (also called “the second port”) of the ePSD 123 bidirectionally and electrically. The DC/AC inverter 122 is connected with the port III (also called the third port) of the ePSD bidirectionally and electrically. As shown in FIG. 1, the automatic transmission 150 is connected with a transmission shaft 160 of the vehicle unidirectionally and mechanically. The at least one driving motor 140 is connected with the inverter 122 bidirectionally and electrically, and connected with the transmission 150 through a coupler 152 bidirectionally and mechanically. The driving motor 140 can be operated for converting the electric energy into the mechanical energy for driving the ACE heavy truck, or converting the mechanical energy of the ACE heavy truck into the electric energy so as to charge the battery pack 130 through the inverter 122 and the ePSD 123.

In this paper, “unidirectional” or “bidirectional” connection refers to whether the direction of the power or energy flowing to the load from the power source is reversible or not, and whether the roles can be switched or not. During unidirectional connection, the roles of the power source and the load are fixed, and the power flow is unidirectional, during bidirectional connection, the roles of the power source and the load can be switched, and the power flow is reversible.

The VCU 201 as one of the key components of the hybrid vehicle is used for controlling one or more of the generator set 100, the ePSD 123, the driving motor 140, the automatic transmission 150 and the battery pack 130 based on the data received from the vehicle-mounted high precision satellite navigation receiver and the navigator through a vehicle-mounted data bus (not shown, such as CAN bus) separately or simultaneously. The satellite navigation receiver and the navigator stated in the invention further comprise one or more input devices, such as a mouse, a keyboard, a touch screen, a keyboard and a voice input device, used for interaction between users and the devices, and can further comprise one or more output devices, such as a display and a loudspeaker.

In some embodiments, the VCU 201 can be an automotive high-performance embedded microprocessor. It should be known that, non-restrictively, the VCU 201 can be also a hardware logic unit, comprising a field-programmable gate array (FPGA), an application-specific integrated circuit (ASIC), an application-specific standard product (ASSP), a system on chip (SOC), a complex programmable logic device (CPLD), etc.

For example, the vehicle-mounted generator set 100 formed by assembling a plurality of subsystems can be commanded by the VCU 201 for converting the chemical energy of the vehicle fuel into the electric energy. For another example, the ePSD 123 can be especially controlled through the VCU 201 for achieving quick smooth switching (subsequently described in detail) among deferent working modes of the hybrid power assembly to meet the requirements of the road load power balance.

FIG. 1 shows one embodiment of the generator set 100, comprising an internal combustion engine (ICE) 101 and an engine control unit (ECU) 102. The internal combustion engine (ICE) 101 is connected with the alternator 110 as the load of the internal combustion engine unidirectionally and mechanically. The generator control unit 121 as the load is connected with the output end of the alternator 110 unidirectionally and electrically, and the three-phase alternating currents output from the alternator 110 are converted into direct currents output to the ePSD 123 unidirectionally. In another alternative embodiment, the generator set 100 can also be of a structure comprising a vehicle-mounted hydrogen fuel cell engine (FC engine) and a direct current/direct current (DC/DC) converter. In view of reduction of hydrogen consumption (g/km) of fuel cells and prolonging of service life, it is expected that the engine works at the high efficiency area for a long time stably, and the condition of transient quick switching is avoided.

Preferably, the internal combustion engine 101 is a diesel or natural gas engine for six-cylinder trucks, with the displacement of 6 L-8 L and the peak power between 170-280 kilowatts. This is because the displacement of the internal combustion engine exceeds 8 L, the peak power of the engine is higher, and the overall power of the vehicle is better, but the fuel-saving effect is reduced. The displacement of the internal combustion engine is lower than 6 L. and the peak power is lower, though the fuel-saving effect is obvious, the overall power of the heavy truck is reduced obviously. It should be known that, optionally, the engine 101 can also be a vehicle gas turbine meeting the above power requirements.

It is noted that, as shown in FIG. 1, in the embodiments of the invention, no mechanical connection between the internal combustion engine 101 and the vehicle transmission shaft is provided, and accordingly the working conditions of the internal combustion engine and the vehicle working conditions are decoupled completely; thus, the foundation enabling the internal combustion engine 101 to stably work at the high efficiency area (including the optimal fuel efficiency range and/or the optimal discharging range) of the universal characteristic curve for a long time is provided. Thus, the fuel consumption and emissions can be reduced. In addition, due to mechanical complete decoupling, the inevitable control delay caused by mechanical connection in the traditional power assembly technology is eliminated, while such mechanical delay is often above “second level”.

Compared with an ignition gasoline engine, a compression ignition diesel engine, with the features of fuel saving, low speed, large torque, practicality, durability, ultra-long life and the like, is the preferred engine for most heavy trucks (exceeding 97%) in the world. However, in the aspect of emissions, especially emissions of nitrogen oxides (NOx) and particulate matter harmful to atmosphere and human health, the diesel engine is poorer than the gasoline engine. The mainstream post-processing commercial technologies for reducing NOx and PM emissions from the heavy truck include selective catalytic reduction (SCR) and diesel particulate filters. The emissions and specific fuel consumption (g/KWH) of the diesel engine are increased during cold start and regulation of instantaneous large output power, while under the working conditions of steady high speed and output power, the emissions and the specific fuel consumption are reduced. The fuel consumption and emissions of the traditional heavy truck are hard to optimize simultaneously within the full speed/torque range of the universal characteristic curve. It can be ensured that the hybrid heavy truck provided by the invention works at the high efficiency area for a long time stably, and the NOx and PM emissions can be reduced while the fuel consumption and carbon emissions are reduced with the synergistic effect. Since the tail gas NOx of the hybrid heavy truck is less, the SCR system can reduce the amount (g/100 km) of consumable urea, thus reducing the operating cost. In addition, the DPF of the hybrid heavy truck works at the high efficiency area for a long time stably, and the shortcoming of time consumption and excessive fuel consumption in staged active regenerative elimination of particulates including deposition through the DPF are eliminated basically, which further reduces the operating cost. For most domestic engines and key power assembly component suppliers with insufficient technological accumulation, the Limits and Measurement Methods for Emissions from Light-duty Vehicles (China VI) coming into force in 2020 for diesel engine heavy trucks are huge technical and business challenges. On the premise of ensuring that the complete vehicle reaches and continuously meets the requirements of China VI, the technical requirements of the diesel engine used by the ACE heavy truck are much lower than the technical requirements of the traditional diesel engine heavy truck. This provides a new field for survival and development of broad heavy truck power assembly suppliers in China in the later period of China VI.

Preferably, the alternator 110 is a permanent magnet alternator, and the rated power is 170-280 kilowatts, and the AC induction motor or reluctance motor meeting the above rated power requirements can also be selected. The peak power of the engine 101 should be matched with the rated power of the alternator 110 to give full play to the respective maximum potentials. Preferably, the generator control unit 121 is an AC/DC converter comprising at least one insulated gate bipolar transistor (IGBT) module, and the rated power of the generator control unit is 170-280 kilowatts. The whole generator set outputs electric energy unidirectionally only and provides the vehicle with the average power on the journey for a long time stably without the regenerative braking function. Therefore, the peak power of the alternator 110 and the control unit 121 only needs to be slightly (e.g. 20%) higher than the rated power.

The ePSD 123 shown in FIG. 3 is a 100-kilowatt power electronic network with three ports, wherein the power electronic network comprises at least one IGBT module, but can exclude any power source or electric energy storage device. Multiple feasible power electronic circuit designs are provided to achieve the functions of the three-port network. It should be noted that the invention is not aimed at limiting the implementation of specific circuits of the three-port network of the IGBT module, but all power electronic circuit designs of different functions of the ePSD (specifically described through the examples shown as follows) should be within the range of the invention. In order to improve the system performance and/or reduce the cost, in view of the integrated design flexibility of the power electronic modules, the ePSD 123 can be further integrated with the AC-DC converter 121 connected with the alternator unidirectionally and/or the DC-AC inverter 122 bidirectionally and electrically.

In the embodiment shown in FIG. 3, the port I of the ePSD as the load is connected with the power output end of the generator set unidirectionally; the port II is connected with the battery pack 130 bidirectionally and electrically, and the port III is connected with the inverter 122 bidirectionally and electrically. However the port II and the port III are never permitted to input electric energy into the ePSD simultaneously. For example, the ePSD can be subjected to pulse-width modulation (PWM) through the IGBT module, and the continuous and adjustable distribution of 100-kilowatt level power is achieved among the three ports within the response time of tens of milliseconds to meet the requirements of the road load power Pv changing continuously during the operation of vehicles in real time. Thus, the ePSD 123 is controlled by the VCU 201, enabling quick and smooth switching among different working modes of the hybrid power assembly; and the fuel consumption and emissions of the internal combustion engine are minimized on the premise of meeting the vehicle driving performance and freight timeliness.

Optionally and additionally, the ePSD can be further provided with a plurality of sensors and memories so as to record the voltage and currents of the ports 1, II and III at the measuring frequency higher than 5 Hz, and the data of the sensors and the memories is regarded as a part of the dedicated structured big data, and real-timely uploaded to the cloud computing platform through the vehicle-mounted wireless communication gateway for subsequent analysis and processing. The following is the description of the implementation mode of the dedicated structured big data.

The known electric power balance equation of the ePSD is: P₁÷P₂=P₃. Where. P1ϵ[0, P_{gx}],P2ϵ[−P_{bx}, P_{bx}],P3ϵ[−Pₘₐₓ, Pₘₓ]. P_{gx} is the maximum output power (slightly lower than the peak power P_{ICE} of the internal combustion engine) of the generator set, and P_{bx} is the maximum discharging power of the battery pack; and Pₘₓ is the maximum power of the driving motor, P_{bx}>Pₘₓ. P₁ is the output power of the generator set, and the minimum value is zero, and cannot be negative. P2 is the battery power, the positive value is the discharge power, and the negative value is the charge power. P₃ is the driving motor power, the positive value is the driving power, and the negative value is regenerative power for regenerative braking and power generation for the purpose of recycling energy. The invention provides a pure electric vehicle, so the driving power is equal to the road load power (P₃=Pᵥ).
Mode 1: The vehicle is static, P₁+P₂=0, the battery pack is charged by the generator set through the ePSD.
Mode 2: The vehicle runs on a level road or uphill. P₁+P₂=P₃ When P₁>P₃>0, the driving motor is powered through the generator set, and the vehicle power is provided, and the surplus power is used for charging the battery pack. When P_{gx}<P₃, the driving motor is powered through the generator set and the battery pack simultaneously, and then the power requirements of the vehicle can be met. If the fuel saving needs to be maximized, the internal combustion engine should be work at the high efficiency combustion area within the specific torque and speed range for a long time stably, or the internal combustion engine should be idle at low power, even idle completely. P₂ changes following P₃ through dynamic regulation of the ePSD quickly and reversely, and P₁ remains constant (P₁=P₃(t)−P₂(t)). In other words, the VCU can be used for stably setting the working point of the internal combustion engine to be at the high efficiency area where the specific fuel consumption (g/KWH) is minimum, and commanding the ePSD to quickly regulate the charge and discharge of the battery pack, so as to offset the transient change of driving motor power and save fuel. If the vehicle meets a large upslope with the longitudinal slope of more than 2 degrees and the slope length of larger than 10 km, since the total capacity of the battery pack is limited, the battery pack may be run off in the depleting mode; at the moment, the vehicle can be driven by the generator set P_{gx} only, fail to reach the road load power for running uphill at constant speed, and shifts gears to speed down uphill. At the moment, the power and freight timeliness of the hybrid heavy truck are reduced momentarily.
Mode 3: When the vehicle runs on a large downhill, P₁ can be set to 0, and at the moment P_{g} is negative; and the slope power exceeding Pᵣ+P_{d} is used for charging the battery pack through the regenerative braking function of the driving motor. At the moment, the vehicle runs downhill, and can reach the maximum speed allowed by laws for making up for part of lost time taken by the vehicle speeding down on an upslope.

In terms of the battery pack, the hybrid heavy truck has fewer restrictions on the volume and weight of the battery pack, but the cells of the battery pack must have the characteristics of ultra-long life, low temperature resistance, high power, safety and reliability, and high cost performance. For example, suppose that the comprehensive energy efficiency of the battery pack and the driving wheels is higher two times than the comprehensive energy efficiency of the fuel tank and the driving wheels of the traditional diesel vehicle; the total mileage traveled by a long-distance freight traditional diesel heavy truck is 193200 km/year, and the overall fuel consumption is 38 L/00-km; the system life should be five years, and the ACE heavy truck saves fuel by 30% than the traditional diesel vehicle, the 100% Depth of Discharge (DoD) cycle life of a 30-KWh battery pack needs to reach 10 thousand times above. The battery pack is used in the high rate partial state of charge (HRPSoC) for a long time; for example, the continuous charge current is 6 C. and the peak charge current is 15 C; and the state of charge range is centralized between 25%-28%. The ACE heavy truck is required to start off and run properly two minutes of warm-up after parking overnight at −30° C. outdoors in winter.

Preferably, the battery pack can adopt lithium titanate oxide (LTO) cells with the capacity of 16 KWh-48 KWh, and can be charged for 5 C˜10 C continuously; the pulse peak charge current is 10C˜20 C. and the 100% DoD life exceeds 10 thousand times; and the outdoor working environment temperature is −30° C.˜+45° C. Among known commercialized automotive power batteries of various electrochemical formulations, only a set of LTO cells can meet the above strict requirements, but the cost (yuan/Wh) of the cells per kilowatt-hour (KWh or degree) is above three times the cost of automotive lithium ion cells of other electrochemical types. The following power cells, such as NiMH battery. LFP battery. NCM/NCA battery or PbC battery, suitable for HRPSoC applications in severe working environment can be further selected. Two sets of such four kinds of cells may be required for meeting the requirements of the 100% DoD ultra-long cycle life exceeding 10 thousand times. The hybrid collocation of the above several kinds of cells can be taken into consideration, and the gross capacity of the battery pack is increased to 50 KWh-95 KWh so as to achieve the optimal cost performance of the battery pack within the whole life cycle. A large battery pack with the capacity of larger than 100 KWh can be also selected, and the improvement of the power performance of the complete vehicle is benefited; the upper limit value of the equivalent cycle life of the battery pack is reduced, but the weight, volume and cost of the large battery pack are all increased; and comprehensive consideration is required. Preferably, the rated DC voltage of the battery pack is 600V˜860V.

In the invention, the function of the battery pack is like a large displacement engine with a small fuel tank, and the explosive power is high, but the endurance is insufficient. The battery back can be used for providing the maximum rated power of the driving motor for a long time (with 5-20 minutes) continuously, or providing the maximum peak power of the driving motor for a short time (within 30 seconds). Provided that the capacity of the battery pack is 30 KWh, and the rated power of the driving motor is 300 KW; the battery pack (the capacity is 30 KWh) in the 100% state of charge (100% SoC) can be used for power supply (10 C discharge) to the driving motor for 6 minutes at the 300-KW strength continuously so that the full load hybrid heavy truck (40 tons) runs for approximately 10 km at the statutory speed limit of 90 km/h on a smooth car-free highway. The stored electric energy in the battery pack can be regarded as “near zero cost energy”. If the rate of fuel saving needs to be improved, the energy in the battery pack should be quickly discharged as far as possible, and charged as being discharged; the charge turnover rate or the throughput capacity of the battery pack is improved; and power is supplied for vehicle running through the driving motor. However, when the SoC of the battery pack is lower than 20%, and the vehicle needs to continuously speed up or run on a large slope, the road load power of the vehicle is larger than the rated power of the generator set; and at the moment the power difference should be continuously compensated through the power pack (P₂=Pᵥ−P₁). At the moment, if the battery pack is under a charge depleting condition (SoC=0%), the ACE heavy truck can only shift gears temporarily to speed down, reducing the power performance and freight timeliness of the vehicle. Until the vehicle runs on a level road or downslope, the generator set and/or the driving motor can take a chance for charging the battery pack again.

Continuously refer to FIG. 3, and the DC port of the inverter 122 is connected with the port III of the ePSD 123 bidirectionally and electrically, and the AC port of the inverter is connected with the input end of the driving motor 140 bidirectionally and electrically. The output end of the driving motor is connected with the automatic transmission 150 through a mechanical coupler 152 bidirectionally and mechanically. On one hand, the direct currents from the ePSD is converted into the three-phase alternating currents, and the driving motor is controlled in a Vector Control mode accurately; the road load power requirements of the vehicle are met in real time; on the other hand, the three-phase alternating currents (negative acceleration power during braking on the level road or the negative slope power during downhill) generated by the driving motor 140 in the regenerative braking mode can be converted into the direct currents for charging the battery pack 130 through the ePSD.

Preferably, the driving motor 140 is a permanent magnet three-phase AC motor with the rated power of 220 KW-380 KW, the peak power of 360 KW-550 KW and the peak torque of 1800 NM˜2600 NM. The driving motor can be also an AC induction motor or a reluctance machine meeting the power and torque requirements. The power requirement of the inverter 122 should be matched with the power requirement of the driving motor. Since the annual sales of the hybrid passenger vehicles is higher two orders of magnitude than the annual sales of the hybrid commercial vehicles, some core components shared with the commercial vehicles are selected as far as possible, and the cost of the commercial vehicles can be reduced effectively. The rated power of a single motor and inverter for the electric (hybrid) passenger vehicles is generally lower than 150 KW. One preferred embodiment is to select a nine-phase permanent magnet AC motor and a nine-phase AC output inverter matched with the nine-phase permanent magnet AC motor. The nine-phase permanent magnet AC motor is actually formed by integrating three smaller three-phase permanent magnet AC motors in the coaxial/same shell mode, and the corresponding nine-phase inverter is formed by integrating three independent smaller inverters in the same shell. Such multi-phase motor+multi-phase controller structure has redundancy, and the comprehensive cost of the whole system can be reduced; and the performance and reliability of the system are improved. The power parameters of the motor and the controller are beyond the above range, and the hybrid heavy truck can further work, but the economy of the ultra-low configuration is improved but the power performance is reduced, or the power performance of the over-high configuration is improved but the economy is reduced. For the 6×4 hybrid system in FIG. 2, a main driving motor 140 (M1) and an auxiliary driving motor 170 (M2) are adopted. At the moment, the main driving motor M1 can be preferably a permanent magnet three-phase or six-phase AC motor with the rated power of 150 KW˜230 KW. The auxiliary driving motor M2 can be preferably a large torque permanent magnet AC motor with the rated power of 100 KW-150 KW and the peak torque of more than 1600 NM (Newton-meter), and is connected with a single-stage speed reducer or a direct drive rotating shaft 180. At the moment, the inverter can be a six-phase or nine-phase motor controller with the total rated power of 250 KW˜400 KW.

The input end of the transmission 150 is connected with the output end of the driving motor 140 through the mechanical coupler 152 bidirectionally and mechanically, and the output end of the transmission is connected with a rotating shaft 160 bidirectionally and mechanically. Preferably, the heavy-duty automatic transmission (AMT-6˜AMT-12) with the input end maximum torque of higher than 2000 Nm is adopted, or the heavy-duty double-clutch transmission (DCT) or the automatic transmission with a hydraulic torque converter can also be selected. Different from the dynamic characteristic that the torque is smaller during low speed of the internal combustion engine, the torque of the driving motor is maximum during low speed, so the forward gears of the automatic transmission are sufficient, and excessive gears are not required. However, the maximum power of the transmission is not traditional one-way mechanical transmission but two-way mechanical transmission, and main bearings and gears in the automatic transmission should be strengthened, and then it can be ensured that the performance and life of the automatic transmission can reach the standard.

The above descriptions are the theoretical basis and hardware basis for the ACE heavy truck system to save fuel and reduce emissions, and the further description on how to use the three-dimensional map, vehicle-mounted navigation equipment and structured big data stored in the cloud computing platform (such as the cloud server), in combination with the machine learning algorithm and cloud platform computing power for training “fuel-saving artificial intelligence”, to achieve the predictive adaptive cruise of “fuel saving+artificial intelligence” of the ACE heavy truck in the same lane on a highway.

In some embodiments, the ACE heavy truck is equipped with a navigator 240 and a satellite navigation receiver 220. The navigator pre-stores a three-dimensional electronic map covering all highways and other main semi-closed roads, while the three-dimensional map information includes but is not limited to: the longitude and latitude of a whole journey highway, especially the information indicating the longitudinal road slope (the upslope angle αᵤ and the downslope angle α_{d} as shown in FIG. 4). For example, the memory of the vehicle-mounted navigator 240 shown in FIG. 1 can comprise the three-dimensional map containing road meter-level positioning (longitude and latitude) and longitudinal slope information with the longitudinal accuracy of 0.1 degree. Various advanced driver assistance system maps containing the above road three-dimensional information have already commercialized and applied in batches worldwide.

The satellite navigation receiver is used for real-timely measuring the longitude, latitude, altitude, longitudinal road slope and longitudinal linear speed of the position (namely the current position) where the vehicle is located. In some embodiments, the satellite navigation receiver (short for RTK receiver) adopting a dual-antenna input carrier phase real-time kinematic (RTK) differential technology can be used for real-time accurate positioning and attitude determination of the heavy truck at the measuring speed of ten times per second (the measuring frequency is 10 Hz). At present, an international navigation satellite system (GNSS) has four independent systems, namely GPS of America, Glonass of Russia. Galileo of European Union and BeiDou (BD) of China. At present, the BeiDou Navigation Satellite System III (BDS-3) can provide latest satellite navigation services for Asian-Pacific regions taking China as the core as well as the countries along “One Belt and One Road”, and it is predicted that the global coverage can be finished in 2020. In addition, the agreement of compatibility for the BeiDou navigation satellite system in China with other three systems has been signed. Preferably, the satellite navigation receiver 220 comprising the latest BDS-3 RTK chip is matched with the two satellite antennas 221 and 222 installed on the top of the heavy truck cab at the interval of at least 1 m, and the time service, speed, position (longitude/latitude), and longitudinal attitude (namely road longitudinal slope angle) of the vehicle are calculated in real time. The RTK chips can finish calculation of satellite navigation positioning and attitude determination according to the received independent signals of four navigation satellites combined in the four systems of the GNSS. The timing accuracy is 50 nanoseconds, and the speed measuring accuracy is 0.2 m/s; the longitude and latitude positioning accuracy of the horizontal plane is smaller than 2.5 m, and the longitudinal grade angle of the highway is smaller than 0.15 degree; and the maximum measuring frequency is 10 Hz. The vertical altitude of the road surface under the wheels cannot be measured through the RTK navigator real-timely and accurately. In addition, the surveying, mapping and issuing of accurate altitude information are controlled in many countries in the world strictly. Fortunately; the absolute altitude measuring accuracy of the vehicle road surface in the invention is required to be 25-meter level.

In some embodiments, the VCU can be configured for predictive control over the generator set and the battery pack based on the longitude, latitude and longitudinal road slope (short for longitudinal slope), pre-stored in the navigator 240, of the meter-level interval density on the whole journey highway, and/or based on the longitude, latitude, altitude and longitudinal slope, measured by the RTK receiver 220, of the position where the vehicle is located.

Optionally or additionally, under the condition that the deviation between the information pre-stored in the three-dimensional map and the information actually measured by the satellite navigation receiver 220 is beyond the range of allowable tolerance, especially when the deviation of the longitudinal slope information (as key information of fuel saving) is beyond the range of allowable tolerance, the VCU can control the ePSD based on the actually measured information. If in fact the RTK receiver malfunctions and the three-dimensional map is correct, the three-dimensional map can be selected to prevail through the VCU according to the transient power distribution parameters of the three ports of the ePSD of the ACE heavy truck, the longitudinal linear speed and acceleration of the vehicle and in combination with the three-dimensional map, so as to achieve the automatic error correction function.

Of course, a common single-antenna satellite navigation receiver can be selected to reduce the system cost, namely that the vehicle longitudinal slope is predicted depending on the high accuracy three-dimensional map completely and indirectly. However, this method is in an open cycle, and the longitudinal slope accuracy reaches 0.2 degree below; and no automatic error correction function is provided.

In several embodiments, the following is the exemplary description on how to achieve the fuel saving control through the VCU 201 according to the navigation information (especially the longitudinal slope information). It is indicated that the following specific examples should not be interpreted as restrictions on the protective range of the invention, but for those in the art to understand the invention properly.

For example, in some embodiments, when the measured slope of the slope road section in front of the vehicle is smaller than the predefined first slope threshold (for example, the slope is smaller than 2.0°), and the length of the slope road section is larger than the predefined first length threshold (for example, the length is larger than 10 km), and the internal combustion engine 101 can be commanded through the VCU 201 to drive the alternator 110, and the generated power is improved in advance; most of the generated electric energy is used for providing the driving motor 140 with the required power for the vehicle to run at constant speed, and the residual electric energy is used for charging the battery pack 130. It is especially suitable for the scenarios that the road section in front of the vehicle has a “longer gentle slope”.

In some embodiments, when the slope of the road section in front of the vehicle is smaller than the predefined second slope threshold (for example, the slope is smaller than 3.00) and the length of the slope road section is smaller than the second threshold (for example, the length is smaller than 10 km, or even smaller than 2 km), the internal combustion engine can be commanded by the VCU 201 and switched to the idle position to work; at the moment, the output power of the alternator is zero, and the driving motor is powered through discharge of the battery pack 130 only; and the required power for the vehicle to run at constant speed is provided.

It is especially suitable for the scenarios that the road section in front of the vehicle has a “shorter slope” (also called “small slope”). Since the slope length is shorter (for example, the slope length is smaller than 2 km), the vehicle has climbed to the top of the slope before the release of the stored electric energy is finished; and the battery pack can be soon recharged through regenerative braking in the subsequent downhill phase, and the energy is recovered. In this way, the electric energy in the battery pack can be utilized for charge and discharge for many times as far as possible, and the cost performance is higher than the cost performance of the scheme in which lots of electric energy is pre-stored in the 100-KWh large capacity battery pack.

As mentioned above, the inventor finds that, depending on the several-kilometer level electronic horizon of the vehicle-mounted three-dimensional map, fuel saving strategies for existing traditional fuel heavy trucks can save fuel by 3% or below through the predictive cruise control. However, the predictive cruise strategies of the traditional heavy truck cannot be applied to such conditions that the length of the slope road section is shorter and the slope is smaller, namely the conditions of“small slope” (for example, the length of the slope road section is smaller 2 km and the longitudinal slope is smaller than 2.0 degrees). This is mainly because the mechanical connection is still maintained between the internal combustion engine and the rotating shaft of the traditional fuel heavy truck, and the mechanical power assembly is inappropriate to change the output power of the internal combustion engine greatly and instantaneously (sub-second level) and shift gears of the automatic transmission. Thus, the traditional predictive cruise control is only suitable for the called “large slope” with the longitudinal slope of larger 2.0 degrees and the slope length of the several-kilometer level, but ignores many “small slopes”. In addition, the traditional fuel heavy truck has no regenerative braking function, and the energy cannot be recovered. In this way, the traditional fuel heavy truck implements predictive power control in long-distance freight scenarios, and will lose lots of chances of accumulative micro fuel saving; and the overall fuel consumption drop of the traditional fuel heavy truck is hard to exceed 3%. As mentioned above, a traditional fuel heavy truck can use the electronic horizon within 5 km only. The electronic horizon within the range of smaller than 1 km and larger 10 km has no practical significance to the fuel saving through predictive control.

In some embodiments, when the slop of a road section in front of the vehicle is basically zero (the longitudinal slope α is between +1.0°) in a quite long distance (such as 10 km) or only the above “small slope” exists, the VCU can take the state of charge (SOC) of the battery pack into consideration dynamically. For example, when the SOC of the battery pack higher than the first charge threshold (e.g., SOC is higher than 80%) is detected, the output power P₁ of the generator set can be reduced and even reduced to zero, and the driving motor can be mainly powered by the discharge power P₂ of the battery pack to supply vehicle running power. If the SOC of the battery pack lower than the second charge threshold (e.g., SOC is lower than 20%) is detected, the output power P₁ of the generator set should be adjusted high until its peak P_{gx} is reached, and the main electric energy generated should be used to supply power to the driving motor to supply vehicle power, and the remaining electric energy generated should be used to charge the battery pack. In this way, ensure the electric quantity in the battery pack would not be used up, and some electric quantity is always stored to supply explosive power required for vehicle acceleration.

In some embodiments, when a “long slope” with the slope larger than the first slope threshold (e.g., the slope is larger than 2.0°) and the slope length larger than 10 km appears in the front road section away from the predetermined distance (e.g., the front position of 10 km above) from the current position of the vehicle, the VCU can command the generator set to generate electricity with the maximum power P_{gx} in advance, and use a part of the electric energy generated to drive the motor to supply vehicle power, and use the remaining part of the electric energy generated to charge the battery pack basically so that the battery pack is fully charged (SOC=100%) when the vehicle runs to the road section with this “long steep slope”. In this way, the battery pack can supply power to the driving motor with the generator set through the ePSD in the working mode of charge depleting after the vehicle enters a long slope section, so as to meet the requirements of vehicle driving power and freight timeliness. When the remaining electric energy of the battery pack is sufficient to drive the vehicle to the top of slope, the VCU commands the generator set to reduce to zero output in advance, uses up the electric energy in the battery pack basically where the vehicle runs downhill, and then quickly charges the battery pack through regenerative braking by means of hundreds of kilowatts of negative slope power in long downhill, thus achieving fuel saving.

With reference to FIG. 1, in view of driving safety, in some embodiments, the heavy truck can further comprise an automotive millimeter-wave radar module 230 and an antenna 231 that are mounted in the front end of the heavy truck, used for monitoring the distance and the relative speed between the heavy truck and its front following vehicle in real time. The detection range of the called millimeter-wave radar is between 100 m˜200 m.

In some embodiments, the heavy truck can further comprise a vehicle-mounted wireless communication gateway 210, used for connecting the heavy truck with a cloud computing platform 001 through WiFi and the 3rd/4th/5th generation cellular mobile network 002 (see FIG. 4).

In this way, the VCU 201 can receive signals from numerous vehicle sensors including the RTK receiver 220 and the millimeter-wave radar 230, so as to control numerous modules or subsystems including the engine control module 102, the alternator 110+the generator control unit 121, the ePSD 123, the battery pack 130, the driving motor 140+the inverter 122, the Tran 150+the transmission control unit (TCU) 151, and the navigator 240 in real time, thus achieving the Predicative-Adaptive-Cruise (PAC) function of the vehicle in the same highway lane through the “symphony type” multi-module coordination and ensuring the minimized comprehensive fuel consumption.

The VCU can achieve minimized comprehensive fuel consumption for the whole journey by making use of electronic horizon three-dimensional road information within 50 km and even 500 km effectively, and through the precision real-time predictive power control for an accumulative 50 m road section.

Besides, truck drivers can also artificially activate or inactivate the additional PAC function, also called as L1.5 level automatic drive function, after driving to a highway. This function (PAC) relaxes driver's feet, alleviates the driving fatigue strength, and achieves automatic acceleration, deceleration, cruise and slide of the ACE heavy truck in the same highway lane.

In some embodiments, the above PAC can comprise the following three modes: normal mode, fuel-saving mode and high-performance mode.

For example, for a passenger vehicle with the gross weight of 2 tons, its maximum power is 100 KW; but for a full load heavy truck with the gross weight up to 40 tons, its maximum power is only 350 KW. It is difficult for a heavy truck to keep constant speed and follow the front passenger vehicle with a constant distance when running on an open highway. It needs to set the upper and lower limits of cruise speed and determine the cruise speed zone of the heavy truck with the cruise speed Vc selected by drivers as an intermediate value. Such three modes have different focuses, wherein, the normal mode gives consideration to fuel saving and freight timeliness; the fuel-saving mode emphasizes fuel saving but relaxes freight timeliness; the high-performance mode emphasizes freight timeliness but relaxes fuel saving. Preferably, the upper and lower limits of the following cruise speed zones can be selected.

In normal mode, the cruise speed of (1.0−0.08)Vc<V<(1.0+0.04)Vc and legal maximum speed; in fuel-saving mode, the cruise speed of (1.0−0.12)Vc<V<(1.0+0.04)Vc and legal maximum speed; in high-performance mode, the cruise speed of (1.0−0.04)Vc<V<(1.0+0.10)Vc and legal maximum speed.

The VCU dynamically adjusts the safe following distance Ls of adaptive cruise control according to the vehicle configuration and state information including the gross weight and vehicle speed, and combining with the current longitudinal slope information of the vehicle as well as the longitudinal slope distribution, bend curvature and other three-dimensional information of ten kilometers of roads in front of the vehicle stored in the navigator. When the distance between a heavy truck and its front vehicle is less than Lₛ, the VCU will remind drivers by giving an alarm of internal acoustic, visual, tactile and other multiple signals. At the same time, the VCU controls the generator set and the driving motor to reduce their output power gradually, and then increases the regenerative braking power gradually to slow down the vehicle after the output power of the driving motor reduces to zero, and recover energy by charging the battery pack. However, the 500 KW maximum regenerative braking power of the driving motor can only meet the auxiliary braking requirement with deceleration less than 0.1 g for a full load heavy truck running at high speed. In emergencies, the driver must step on the brake and start the mechanical braking system of the heavy truck to achieve emergency braking with deceleration larger than 0.2 g. The driver response time+mechanical braking system response time exceed 1.0 s. However, the above operation of the VCU can be completed in 25.0 ms, dozens of times faster than the response speed of the human+mechanical system. In addition, the PAC of the ACE heavy truck can improve driving safety and reduce rear-<nd collisions.

It is predicted that the large-scale business of “Truck Platooning” of heavy truck can be implemented in relatively open closed highway areas in Europe and America in 2019. The “Truck Platooning” of heavy truck means reducing the safe following distance between two heavy trucks running at high speed from the regulatory 50 m above to 15 m below greatly through a complete set of advanced driving assistant system (ADAS)+a real-time reliable communication (V2V) between vehicles, which helps to reduce the wind resistance power between the front and rear vehicles obviously, save 4% fuel of the leading heavy truck and save 10% fuel of the following heavy truck. In view of safety, the emergency braking performance of the following heavy truck should be superior to the leading heavy truck, so as to avoid rear-end collisions. The high speed emergency braking performance in the same lane of the ACE heavy truck is superior to traditional fuel heavy truck with the same load, therefore the ACE heavy truck is applicable for serving as following heavy truck in the truck platooning of heavy truck, which can further save fuel. In view of fuel saving only, smaller following distance in truck platooning is not better. When the following distance is less than 7 m, the effective wind speed of the front water tank of the following heavy truck will be reduced; and at the moment, it is required to start the water tank fan with power dissipation of tens of kilowatts to provide the dynamic heat dissipation power required for the heavy truck diesel engine, which results in no reduction and rise of comprehensive fuel consumption of the following heavy truck. The diesel engine displacement of the ACE heavy truck is reduced by 40% than traditional heavy truck, which means both area and heat dissipation power of its water tank are reduced by about 40%; and compared with traditional heavy truck, the ACE heavy truck has faster braking response speed and shorter braking distance, therefore, served as a following vehicle, the ACE heavy truck can shorten the safe following distance to 6 in. and may achieve more than 10% fuel saving rate by reducing the wind resistance power.

It needs to be emphasized that the realization of reduced 30% comprehensive fuel consumption of the ACE heavy truck than traditional heavy fuel truck through the PAC in the same highway lane described in the invention mainly depends on optimization for gas-electric hybrid power assembly technology. Different from the automatic drive vehicles above L3, the ACE heavy truck of the invention uses the mature and commercial core components and system integration technology. All other effective fuel saving technologies of commercial heavy truck such as low rolling friction tire, light weight and reduced wind resistance aerodynamics (towing vehicle head+trailer) can be directly superposition-applied to the ACE heavy truck, therefore compared with 2015 edition of traditional fuel heavy truck, the commercial ACE heavy truck around 2021 can reduce by more than 40% reference comprehensive fuel consumption.

Besides, for an ACE heavy truck with battery pack of only tens of kilowatts, the plug-in hybrid technology is completely feasible but doesn't make much business sense. The invention is substantially an advanced extended-range electric heavy truck without plug-in function. As discussed above, when running on a loaded highway, the ACE heavy truck can harvest kilowatt-hours of “zero cost electric energy” from each downhill between tens of meters and several kilometers through charging the battery pack by skillfully using the slope power with downhill negatives between tens of kilowatts and hundreds of kilowatts generated from subtle second level fast change with longitudinal slope 0.1° that frequently occurs. Every little helps. The comprehensive energy conversion efficiency from the battery to the driving wheel is as two times as that from the fuel tank to the driving wheel. In other words, compared with the chemical energy in the fuel tank, the electric energy in the battery pack can make one to three. The secret of the ACE heavy truck saving fuel under the working condition of highways is to maximize the approximately zero cost electric energy in the battery pack, supply the driving power of fast change of partial vehicles, and increase the total charging and discharging electric energy of the whole journey of the battery pack through the fast turn around method of discharging with charging, so as to achieve the fuel saving effect. The VCU considers the situation in real time according to the three-dimensional map of the whole journey road, so as to ensure the battery pack can be fully charged in advance with enough time before the vehicle meets a big and long slope with length of kilometers above, and avoid the peak power of the generator set is insufficient to independently support the vehicle to run uphill at constant speed after the battery pack is used up in the vehicle climbing process. According to the vehicle-mounted three-dimensional map, especially the high precision distribution information of longitudinal slope in the whole journey, the VCU can real-timely and dynamically predict the vehicle slope power time function in the whole journey under the 10-kilowatt level precision, so as to dynamically and predictively adjust the SoC of the battery pack, and pursue the optimal balance among the fuel saving effect, power and freight timeliness of the ACE heavy truck at the PAC mode selected by drivers. It needs to be emphasized that the optimal value of the daily driving comprehensive fuel consumption of an ACE heavy truck is closely related to the configuration and load of this vehicle, longitudinal slope space-time function along the way of the specific journey (or route), weather conditions along the way on that day, traffic condition along the way, etc., but has no relation with the macroscopic average fuel consumption value of the heavy trucks with similar configuration and load in the whole province and even throughout the country. If the daily average fuel consumption is the minimum, it can ensure the comprehensive fuel consumption of this ACE heavy truck is optimal within the full life cycle from month to month. For all ACE heavy trucks with different configurations and loads, the dedicated structured big data in a specific journey that are formed from month to month have guiding significance for each ACE heavy truck that is operated in this journey.

How to upload the dedicated structured big data that are recorded in the above numerous ACE heavy trucks during the driving period to the cloud computing platform for storage via a mobile Internet through a vehicle-mounted wireless gateway after encryption for subsequent analysis and processing is described below.

The cloud platform assembles enough computing power through the specific algorithm of machine learning, trains the “fuel-saving artificial intelligence” through the increasingly accumulated dedicated structured big data, seeks the optimal fuel-saving strategy for specific journeys by focusing on collective intelligence, and serves for individual ACE heavy trucks, providing fuel consumption reference value and default optimal fuel-saving strategy for specific journeys for them so that each ACE heavy truck can benefit from them. Each heavy truck performs “edge computing” by means of its VCU, and real-timely and dynamically modifies the fuel-saving strategy according to the current environment and vehicle operating data, achieving minimized comprehensive fuel consumption of this journey.

In some embodiments, in the vehicle driving process, the operating measurement data from all subsystems including the above generator set, the ePSD, the driving motor+the inverter, the automatic transmission, the battery pack, etc. can be stored in memorizers such as VCU in the structured mode. Of course, it is also feasible to store the measurement data in the memorizers of microprocessors corresponding to subsystems. The “structured data” refers to multiple data that are “relatively” recorded through a “mapping relation”.

For example, it can dynamically calibrate microprocessor clocks of all vehicle-mounted subsystems including the VCU clock by means of 10-nanosecond level ultrahigh precision time service of the global navigation satellite system (GNSS), and annotate the structured big data with the orderly unique time. As shown in FIG. 1 and FIG. 2, all important subsystems on the vehicle, including the VCU 201, the generator sets 101, 102, 110 and 121, the driving motor assemblies 140, 170 and 112, the ePSD 123, the battery pack 130, the Tran 150 and 151, the millimeter-wave radar 230, the mobile communication gateway 210, the navigator 240, the RTK receiver 220, etc., have dedicated microprocessors, memorizers and sensors. All these subsystems can calculate and record their main operating parameters annotated with time in real time locally with a measurement frequency (fm) within the range of 0.1 Hz<fₘ<50 Hz. For example, the engine control module 102 can calculate and record the data such as vehicle speed and speed, torque and brake specific fuel consumption (BSFC) of the engine 101 with a measurement frequency of 20 Hz, the generator control unit 121 can record the data such as input mechanical speed and torque and internal temperature of the alternator 110 and output DC voltage and current and internal temperature of the generator control unit 121 with a measurement frequency of 20 Hz; the ePSD 123 can record the data such as DC voltage and current of their three ports and its internal temperature with a measurement frequency of 20 Hz; the battery pack 130 can record the data such as its output DC voltage and current, and current, voltage, temperature and SoC of its internal cell and cell module levels with a measurement frequency of 10.0 Hz; the inverter 122 can record the data such as output mechanical speed and torque and internal temperature of the driving motors 140 and 170 and input DC voltage and current and internal temperature of the inverter 121 with a measurement frequency of 20 Hz; the TCU 151 can record the data such as transmission position, input end speed and output end speed with a measurement frequency of 1.0 Hz; the RTK navigator 220 can record the data such as speed per hour, longitude and latitude, longitudinal slope and time service of vehicle with a measurement frequency of maximum 10 Hz; the millimeter-wave radar 230 can record the data such as distance and relative speed between the vehicle and the front vehicle with a measurement frequency of 10 Hz. The sensor measurement parameters of subsystems have overlapping each other, and the redundancy helps to improve the fault tolerance and error correction of the whole system.

Next, as shown in FIG. 4, the VCU 201 collects and assembles the structured big data packet (short for “fuel saving data packet”) related to the vehicle fuel saving that is generated in the running process of the ACE heavy truck 010 with the time annotation as the reference of all subsystem measurement data.

Later, the “fuel saving data packet” will be “real-timely” (subsecond-level delay) or “timely” (hour-level delay) uploaded to the cloud computing platform for storage via a mobile Internet, for subsequent analysis and processing.

For example, the data packet can be “quasi real-timely” uploaded to the server of the cloud computing platform 001 via the wireless communication gateway 210 (as shown in FIG. 1) and the cellular mobile network 002 for subsequent processing. The “quasi real-time” indicates that the delay of uploading the fuel saving data packet is within several hours. Electively, the data packet can be encrypted before being uploaded to ensure data security. The cloud platform 001 will collect all fuel saving data packets of numerous ACE heavy trucks using the invention. The cloud platform trains the artificial intelligence (AI) brain (short for “fuel-saving AI brain”) of the “fuel saving robot” by means of these increasingly accumulated structured big data of ACE heavy trucks and through the specific algorithm of machine learning, and seeks the optimal fuel-saving control strategy and effect of ACE heavy trucks. The fuel-saving AI brain can perform millions of operations in several milliseconds according to the constantly changed running conditions of the ACE heavy truck, seek a dynamically optimal fuel-saving control strategy in each second and minute of time frame (corresponding to 20 m to thousands of meters of driving distance), command the ePSD 123 to adjust the charging and discharging power of the battery pack with an amplitude of hundreds of kilowatts within tens of milliseconds of response time, keep the ICE of the generator set work stably at the high efficiency area for a long time, and meet the constantly changed vehicle road load power requirement (P_{g}+P_{b}=Pₘ=Pᵥ) in real time. The fuel-saving AI brain finally achieves the macroscopically optimal fuel saving of the whole journey through the microcosmically optimal fuel saving in each minute of time frame and constant accumulation. The fuel-saving AI brain commands the PAC in the same highway lane of the ACE heavy truck to seek the optimal fuel saving effect. Like Alpha Go of Google, it can surpass human.

Both beginning and ending of journey of long-distance freight heavy trucks are pre-known. Before start of freight, the VCU 201 of the ACE heavy truck 010 can automatically require the “fuel-saving AI brain” of the cloud platform 001 to download the optimal fuel-saving control default program and optimal fuel consumption value (L/100 km) for a journey, to serve as a reference for locally real-time operation (edge computing) of the vehicle-mounted fuel-saving AI brain included in the VCU. In this way, we can enjoy the collective intelligence of running in the same road section of ACE heavy trucks in the whole industry, so as to achieve the optimal fuel saving effect. After drivers drive the ACE heavy truck to a closed highway, it can select mode, activate the PAC function, and replace partial driving functions of drivers with the fuel-saving AI brain of the VCU, so as to achieve drive (acceleration/cruise/slide/deceleration) automation in the same lane of the ACE heavy truck, relax driver's feet, reduce the driving fatigue strength of drivers, and achieve the optimal fuel saving effect. Drivers are still responsible for turning and emergency braking of the vehicle and for keeping all-around monitoring on driving of the heavy truck constantly. The other beneficial effect of the intention is that the industrial pain point of large actual comprehensive fuel consumption discreteness of the vehicle caused due to human factors of drivers is eliminated through the control of fuel-saving AI brain, so as to ensure all ACE heavy trucks can uniformly achieve the optimal fuel saving effect when running on the same road section. This highlight is very important to transport companies.

In a word, the essential difference between the ACE heavy truck with PAC function in the invention and any hybrid vehicles and traditional diesel engine heavy trucks with similar function lies in, the former highly focuses on fuel saving, can effectively solve the worldwide problem of not obvious fuel saving effect of hybrid heavy trucks under the working condition of highways than traditional fuel heavy trucks that is recognized in the automobile industry, and can achieve a beneficial effect that the actual long-distance freight comprehensive fuel consumption is reduced by more than 30% and the exhaust pollutant and carbon emissions are reduced greatly.

Although the language specific to structural features and/or method logical actions has been used to describe the topic, it should understand that the restricted topic in the claims may not be restricted to the above specific characteristics or actions described. On the contrary, the above specific characteristics and actions described are only example forms of achieving the claims.

1. A hybrid vehicle, comprising:
a generator set, for converting chemical energy of vehicle fuel into electric energy;
an electric power shunt device (ePSD), configured as a power electronic network with three ports, a first port of the ePSD being connected with an output end of the generator set unidirectionally and electrically;
a battery pack, connected with a second port of the ePSD bidirectionally and electrically;
a DC/AC inverter, connected with a third port of the ePSD bidirectionally and electrically;
an automatic transmission, connected with a drive shaft of the vehicle bidirectionally and mechanically;
a navigator including a previously stored three-dimensional map, the three-dimensional map including three-dimensional information of longitude, latitude, and longitudinal slope of each longitudinal road section where the vehicle travels;
at least one driving motor, connected with the DC/AC inverter bidirectionally and electrically and connected with the automatic transmission bidirectionally and mechanically, the driving motor being operable for converting the electric energy into the mechanical energy to drive the vehicle, or being operable for converting the mechanical energy into the electric energy to charge the battery pack via the DC/AC inverter and the ePSD;
wherein, no mechanical connection exists, either between the generator set and the driving motor, or between the generator set and the automatic transmission; and
wherein, the vehicle further comprises a vehicle control unit (VCU) configured for controlling, via a data bus of the vehicle, at least one of the generator set, the ePSD, the driving motor, the automatic transmission and the battery pack, independently, based on data in an on-vehicle satellite navigation receiver and/or the navigator.

2. The hybrid vehicle according to claim 1, further comprising:
a satellite navigation receiver configurable for calculating in real time the longitude, latitude, altitude, longitudinal slope, and linear velocity of the vehicle, during a travel of the vehicle, the satellite navigation receiver being a dual-antenna carrier phase real-time kinematic (RTK) differential receiver; or
a high precision single-antenna satellite navigation receiver configurable for calculating in real time the longitude, latitude, longitudinal slope, and linear velocity of the vehicle, at a meter level positioning accuracy, during the travel of the vehicle.

3. The hybrid vehicle according to claim 2, wherein the VCU is configured for:
predictively controlling the generator set and the battery pack, based on the longitude and latitude that are calculated by the navigator in real time during the travel of the vehicle, in combination with the longitude, latitude and longitudinal slope of the longitudinal road section within the electronic horizon range in front of the vehicle that are previously stored in the three-dimensional map; and/or
predictively control the generator set and the battery pack, based on the longitude, latitude, longitudinal slope and linear velocity that are calculated by the RTK receiver during the travel of the vehicle, in combination with the longitude, latitude and longitudinal slope of the longitudinal road section within the electronic horizon range in front of the vehicle that are previously stored in the three-dimensional map.

4. The hybrid vehicle according to claim 3, wherein the VCU is further configured for:
predictively controlling the generator set and the battery pack, based on the longitudinal slope calculated by the RTK receiver during the travel of the vehicle and the electronic horizon of the three-dimensional map, in case of detecting that a difference between the longitudinal slope calculated by the RTK receiver and the longitudinal slope of the same position stored in the three-dimensional map exceeds an allowable tolerance.

5. The hybrid vehicle according to claim 1, wherein the VCU is further configured for:
based on a time service of the RTK receiver, calibrating a built-in clock of each subsystem microprocessor of the vehicle, wherein calibrating the built-in clock of each subsystem microprocessor comprises calibrating the built-in clock of the VCU;
assembling, on a first dimension, the measurement parameters and/or operating parameters of at least two subsystems selected from the RTK receiver, the navigator, the generator set, the ePSD, the DC/AC inverter, the driving motor, the automatic transmission and the battery pack;
annotating the assembled measurement parameters and/or operating parameters, according to an unique time sequence provided by the calibrated clock, and arranging the annotated measurement parameters and/or operating parameters on a second dimension to form a dedicated structured data packet that indicates a dynamic operating condition of the hybrid vehicle.

6. The hybrid vehicle according to claim 1, wherein,
the generator set is consisted of an internal combustion engine, an alternator, and an AC/DC converter,
wherein the internal combustion engine is connected with the alternator unidirectionally and mechanically; the alternator is connected with the AC/DC converter unidirectionally and electrically; and the AC/DC converter is connected with the ePSD unidirectionally and electrically.

7. The hybrid vehicle according to claim 6, wherein the VCU is further configured for:
controlling at least one of the internal combustion engine, the battery pack, the automatic transmission and the driving motor, based on a universal characteristic curve digital model of the internal combustion engine, a charge-discharge characteristic digital model of the battery pack, a characteristic digital model of the automatic transmission and a characteristic digital model of the driving motor, respectively.

8. The hybrid vehicle according to claim 7, wherein
the universal characteristic curve digital model of the internal combustion engine comprises an idle operating point without road load and a high-efficiency operating area having a minimum specific fuel consumption of the engine, and
the VCU is further configured for enabling the internal combustion engine to work at the idle operating point or the high-efficiency working area and switch between the idle operating point and the high-efficiency operating area.

9. The hybrid vehicle according to claim 5, wherein the VCU is further configured for:
storing the dedicated structured data packet during the travel of the vehicle; and
sending, via a mobile Internet in a real-time or periodic manner, the structured data packet stored in the vehicle to a cloud computing platform that is located away from the vehicle for storage, so as to provide the dedicated structured data packet required for artificial intelligence training on fuel-efficient strategy to the cloud platform.

10. The cloud computing platform, comprising:
at least one server, each server comprising:
a processing unit; and
a memory, coupled to the processing unit and comprising computer program codes, wherein when the computer program codes are executed by the processing unit, the server executes the following operations of:
receiving dedicated structured data packets from multiple hybrid vehicles, via the mobile Internet, wherein each of the vehicles comprises:
a generator set for converting chemical energy of vehicle fuel into electric energy;
an electric power shunt device (ePSD), configured as a power network with three ports, a first port of the ePSD being connected with an output end of the generator set unidirectionally and electrically:
a battery pack, connected with a second port of the ePSD bidirectionally and electrically;
a DC/AC inverter, connected with the third port of the ePSD bidirectionally and electrically:
an automatic transmission, connected with a drive shaft of the vehicle bidirectionally and mechanically;
a navigator including a previously stored three-dimensional map, the three-dimensional map including three-dimensional information of longitude, latitude and longitudinal slope of each longitudinal road section where the vehicle travels:
at least one driving motor, connected with the DC/AC inverter bidirectionally and electrically, and connected with the transmission bidirectionally and mechanically, the driving motor being operable for converting the electric energy into the mechanical energy to drive the vehicle, or being operable for converting the mechanical energy into the electric energy to charge the battery pack via the DC/AC inverter and the ePSD;
wherein, no mechanical connection exists either between the generator set and the deriving motor, or between the generator set and the automatic transmission;
a vehicle control unit (VCU) configured for controlling, via a data bus of the vehicle, at least one of the navigator, the generator set, the ePSD, the driving motor, the automatic transmission and the battery pack independently, based on data in an on-vehicle satellite navigation receiver and/or the navigator:
designing a dedicated machine learning algorithm, based on the dedicated structured data packets received from the multiple vehicles;
training a fuel-saving artificial intelligence unit, based on the machine learning algorithm, and by using the computing capability of the cloud platform and the stored structured data packets, wherein each of the structured data packets comprises data associated with at least one of the generator set, the ePSD, the inverter, the driving motor, the automatic transmission and the battery pack; and
for a travel that is specific to a vehicle, in response to receiving a request from the vehicle, providing by the fuel-saving artificial intelligence unit a customized fuel-saving strategy as a default initial scheme of the fuel-saving strategy of the vehicle.

11. The cloud platform according to claim 10,
wherein, each of the vehicles further comprises a high-precision satellite navigation receiver for accurately calculating in real time longitude, latitude, altitude, longitudinal slope of a longitudinal road section, and linear velocity of the vehicle during a travel of the vehicle, the high-precision satellite navigation receiver being a dual-antenna carrier phase real-time kinematic (RTK) differential receiver,
wherein, the dedicated structured data received from the multiple vehicles further comprises: multiple road three-dimensional data each comprising longitude, latitude and longitudinal slope, measured by each of the multiple vehicles when traveling at a same road section among a plurality of longitudinal road sections, and
wherein, the operations further comprise:
transmitting the road three-dimensional data measured by the multiple vehicles to an electronic navigation three-dimensional map manufacturer, and
updating the three-dimensional map stored in the navigator of the vehicle.
